(19) United States
(12) Patent Application Publication
(10) Pub. No.: US 2022/0341894 A1
(43) Pub. Date: Oct. 27, 2022

(54) ULTRASONIC SCANNING APPARATUS COMPRISING A BACKING BLOCK

(71) Applicant: DolphiTech AS, Gjøvik (NO)

(72) Inventors: Eskil Skoglund, Gjøvik (NO); Fredrik Lingvall, Oslo (NO); Jan Hjermstad, Gjøvik (NO); Tore Magne Skar, Asker (NO)

(21) Appl. No.: 17/765,533

(22) PCT Filed: Sep. 29, 2020
(86) PCT No.: PCT/EP2020/077228

§ 371 Date: Mar. 31, 2022

(30) Foreign Application Priority Data
Oct. 1, 2019 (GB) 1914166.2

(51) Int. Cl. G01N 29/32; G01N 29/265; G01N 29/42; G01N 29/06; G01N 29/04; B06B 1/06

(52) U.S. Cl. CPC G01N 29/32; G01N 29/265; G01N 29/42; G01N 29/069; G01N 29/043; B06B 1/067

(57) ABSTRACT

A scanning apparatus for imaging an object, comprising an ultrasound transducer comprising a transmitter configured to transmit ultrasound signals in a first direction towards an object and a receiver configured to receive reflected ultrasound signals from an object; and a backing block for absorbing ultrasound signals, located adjacent the transducer along a second direction opposite to the first direction; the backing block comprising an inner surface facing the transducer, the inner surface comprising a non-planar feature configured to increase the absorption of ultrasound signals by the backing block.

### CROSS-REFERENCE TO RELATED APPLICATIONS

This application is the national stage entry of International Patent Application No. PCT/EP2020/077228, filed on Sep. 29, 2020, and claims priority to Application No. GB1914166.2, filed in the United Kingdom on Oct. 1, 2019, the disclosures of which are incorporated by reference thereto.

### FIELD OF THE INVENTION

This invention relates to a scanning apparatus comprising a backing block for absorbing ultrasound signals, and to the backing block.

### BACKGROUND

The scanning apparatus is suitably for imaging an object, for instance for imaging structural features below an object's surface. The scanning apparatus may be particularly useful for imaging sub-surface material defects such as delamination, debonding and flaking.

Ultrasound can be used to identify particular structural features in an object. For example, ultrasound may be used for non-destructive testing by detecting the size and position of flaws in a sample. There are a wide range of applications that can benefit from non-destructive testing, covering different materials, sample depths and types of structural feature, such as different layers in a laminate structure, impact damage, boreholes etc.

Ultrasound is an oscillating sound pressure wave that can be used to detect objects and measure distances. A transmitted sound wave is reflected and refracted as it encounters materials with different acoustic impedance properties. If these reflections and refractions are detected and analysed, the resulting data can be used to describe the environment through which the sound wave travelled. It is desirable to reduce unwanted reflections to increase the accuracy of the analysis.

### SUMMARY

According to an aspect of the present invention, there is provided a scanning apparatus for imaging an object, comprising:
an ultrasound transducer comprising a transmitter configured to transmit ultrasound signals in a first direction towards an object and a receiver configured to receive reflected ultrasound signals from an object; and
a backing block for absorbing ultrasound signals, located adjacent the transducer along a second direction opposite to the first direction;
   the backing block comprising an inner surface facing the transducer, the inner surface comprising a non-planar feature configured to increase the absorption of ultrasound signals by the backing block.

The non-planar feature may be provided across the whole of the inner surface. The non-planar feature may comprise one or more surface protrusion and/or surface indentation. The non-planar feature may comprise one or more of a smoothly curving protrusion and/or indentation; and an angled protrusion and/or indentation. The non-planar feature may comprise one or more of a part-spherical protrusion and/or indentation; and a pyramidal protrusion and/or indentation.

The inner surface of the backing block may comprise a rear surface parallel to the transducer. The inner surface may comprise one or more additional surface provided at an angle to the rear surface. At least a portion of the non-planar feature may be at an angle of greater than 45 degrees to the second direction. At least a portion of the non-planar feature may be at an angle of less than 45 degrees to the second direction.

The inner surface may at least partially define a cavity within the backing block, the cavity being filled with a sound-absorbing material. The sound-absorbing material may comprise one or more of epoxy, silicone, and rubber. The sound-absorbing material may comprise a plurality of particles. The plurality of particles may comprise particles of a range of sizes and/or shapes. The plurality of particles may have a size in their greatest dimension in the range 0.1 μm to 500 μm.

The plurality of particles may comprise particles of differing materials. The plurality of particles may comprise one or more metal. The plurality of particles may comprise one or more of tungsten, nickel, titanium, titanium dioxide, steel and iron oxide.

The sound-absorbing material may be impedance-matched to the transducer. The sound-absorbing material may comprise layers of differing impedance along the second direction.

According to another aspect, there is provided a backing block for absorbing ultrasound signals in a scanning apparatus, the backing block being configured to be locatable adjacent a transducer along a second direction opposite to a first direction in which the transducer is configured to transmit ultrasound towards an object to be imaged, the backing block comprising an inner surface facing the transducer, the inner surface comprising a non-planar feature configured to increase the absorption of ultrasound signals by the backing block.

According to another aspect, there is provided a sound-absorbing material for a backing block of a scanning apparatus, the sound-absorbing material comprising a plurality of particles of a range of shapes and/or sizes for increasing sound absorption of the sound-absorbing material.

According to another aspect, there is provided a scanning apparatus for imaging an object, comprising:
an ultrasound transducer comprising a transmitter configured to transmit ultrasound signals in a first direction towards an object and a receiver configured to receive reflected ultrasound signals from an object; and
a backing block for absorbing ultrasound signals, located adjacent the transducer along a second direction opposite to the first direction;
   the backing block comprising an inner surface facing the transducer, the inner surface at least partially defining a cavity within the backing block, the cavity being filled with a sound-absorbing material comprising a plurality of particles of a range of shapes and/or sizes for increasing sound absorption of the sound-absorbing material.

Any one or more feature of any aspect above may be combined with any other aspect. These have not been written out in full here merely for the sake of brevity.

### BRIEF DESCRIPTION OF THE FIGURES

The present invention will now be described by way of example with reference to the accompanying drawings. In the drawings:

FIG. 1 shows a device for imaging an object;

FIG. 2 shows an example of a scanning apparatus and an object;

FIG. 3 shows an example of the functional blocks of a scanning apparatus;

FIG. 4 shows a schematic illustration of a transducer module;

FIG. 5 shows different paths a signal may take within a backing block;

FIG. 6 shows an example of a non-planar feature in a backing block;

FIG. 7 shows another example of a non-planar feature in a backing block;

FIGS. 8A and 8B show sectional side views of another backing block;

FIG. 9A shows a plan view of the backing block of FIG. 8A;

FIG. 9B shows a perspective view of the backing block of FIG. 8A;

FIGS. 10A and 10B show sectional side views of another backing block;

FIG. 11A shows a plan view of the backing block of FIG. 10A,

FIG. 11B shows a perspective view of the backing block of FIG. 10A,

FIGS. 12A and 12B show sectional side views of another backing block;

FIG. 13A shows a plan view of the backing block of FIG. 12A;

FIG. 13B shows a perspective view of the backing block of FIG. 12A;

FIG. 14 shows an example of a backing block comprising a sound-absorbing material; and

FIG. 15 shows another example of a backing block comprising a sound-absorbing material.

### DETAILED DESCRIPTION

A scanning apparatus can be used for imaging an object. The scanning apparatus can comprise an ultrasound transducer with a transmitter configured to transmit ultrasound signals in a first direction towards an object and a receiver configured to receive reflected ultrasound signals from an object. Analysis of the reflected ultrasound received from the object can be used to analyse the object. Detection of the reflections permits analysis of the subsurface structure of the object. The transmitter will transmit ultrasound signals in directions other than the first direction. Such signals can be minimised by appropriate focusing of the transducer. Some signals will be transmitted in a second direction, which may be opposite to the first direction. These signals may be reflected off surfaces/interfaces behind the transducer, i.e. surfaces/interfaces which do not relate to the object under test. Such reflections can be directed back towards the transducer and can be detected by the receiver. Suitable time-gating of the detected signals can reduce the effect of these undesirable reflections in the analysis. However, some undesirable reflections will be received at the same time as reflections from the object, so cannot be removed using a time gate.

It is desirable to reduce or avoid such undesirable reflections from being detected at the transducer. This can be achieved by providing a backing block behind the transducer (e.g. next to or adjacent the transducer in the second direction). The backing block is suitably configured to absorb ultrasound signals. Such absorption will reduce the energy of any undesirable reflections. Undesirable reflections with a lower energy will have less of an effect on the resulting analysis of the object, leading to an increase in accuracy of the analysis. In an ideal case, the backing block absorbs all signals that pass therethrough. Practically, it may be considered sufficient for the backing block to reduce the intensity of the signals passing therethrough to below a threshold intensity. The threshold intensity may be a proportion of the intensity of the signals transmitted into the backing block. For example the threshold intensity may be 20%, 10%, 5%, 2% or 1%.

The backing block can be configured to absorb ultrasound signals by comprising an attenuating material that attenuates ultrasound signals that pass therethrough. For example, the backing block can comprise an epoxy or other suitable sound-absorbing material. Suitably, the epoxy is impedance-matched to the transducer to reduce or avoid a large reflection at the transducer-epoxy boundary as the ultrasound signals are transmitted by the transducer.

The backing block may be configured to increase the absorption of ultrasound signals by comprising one or more of:
at least one non-planar feature on an inner surface of the backing block (e.g. a surface facing towards the transducer), and
a plurality of particles in the sound-absorbing material.

The non-planar feature can cause an additional reflection of the ultrasound signal before it is detected back at the transducer. The non-planar feature can alter the path of the reflection before it is detected back at the transducer. The non-planar feature suitably causes the path length of the reflected signal to increase before it is received at the transducer. A longer path length will cause the reflected signal to lose additional energy before detection. Each reflection of the signal will cause an additional loss of energy. Hence a greater number of reflections can cause a reduction in the energy of the signal. Additional reflections which also cause the path length to increase cause further reductions in the signal energy. Thus the non-planar feature can increase the signal attenuation in the backing block.

The sound-absorbing material can be provided with a plurality of particles. The particles are suitably of a different acoustic impedance to the sound-absorbing material itself. Thus the particles present impedance-mismatched boundaries within the sound-absorbing material which can cause additional reflections of ultrasound signals. These additional reflections can increase the path length through the sound-absorbing material of the signals, and hence reduce their intensity.

These approaches for increasing the absorption of signals by the backing block will be described in more detail below.

A scanning apparatus may gather information about structural features located different depths below the surface of an object. One way of obtaining this information is to transmit sound pulses at the object and detect any reflections. It is helpful to generate an image depicting the gathered information so that a human operator can recognise and evaluate the size, shape and depth of any structural flaws below the object's surface. This is a vital activity for many industrial applications where sub-surface structural flaws can be dangerous. An example is aircraft maintenance.

Usually the operator will be entirely reliant on the images produced by the apparatus because the structure the operator wants to look at is beneath the object's surface. It is therefore important that the information is imaged in such a way that the operator can evaluate the object's structure effectively.

Ultrasound transducers make use of a piezoelectric material, which is driven by electrical signals to cause the piezoelectric material to vibrate, generating the ultrasound signal. Conversely, when a sound signal is received, it causes the piezoelectric material to vibrate, generating electrical signals which can be detected.

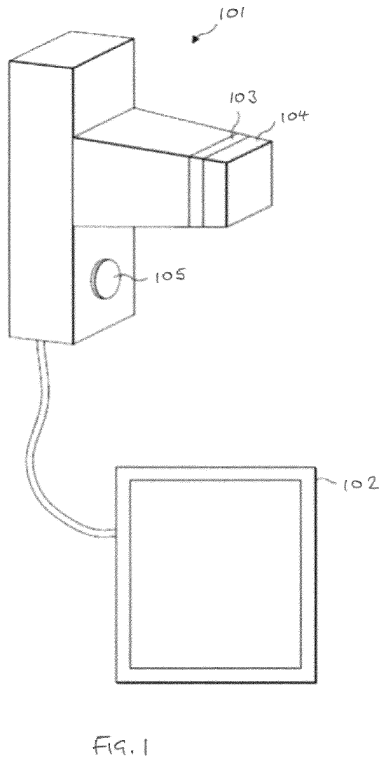

An example of a handheld device, such as a scanning apparatus described herein, for imaging below the surface of an object is shown in FIG. 1. The device 101 could have an integrated display, but in this example it outputs images to a tablet computer 102. The connection with the tablet could be wired, as shown, or wireless. The device has a matrix array 103 for transmitting and receiving ultrasound signals. Suitably the array is implemented by an ultrasound transducer comprising a plurality of electrodes arranged in an intersecting pattern to form an array of transducer elements. The transducer elements may be switched between transmitting and receiving. The handheld apparatus as illustrated comprises a coupling layer such as a dry coupling layer 104 for coupling ultrasound signals into the object. The coupling layer also delays the ultrasound signals to allow time for the transducers to switch from transmitting to receiving. A dry coupling layer offers a number of advantages over other imaging systems, which tend to use liquids for coupling the ultrasound signals. This can be impractical in an industrial environment. If the liquid coupler is contained in a bladder, as is sometimes used, this makes it difficult to obtain accurate depth measurements which is not ideal for non-destructive testing applications. The coupling layer need not be provided in all examples.

The matrix array 103 is two dimensional so there is no need to move it across the object to obtain an image. A typical matrix array might be approximately 30 mm by 30 mm but the size and shape of the matrix array can be varied to suit the application. The device may be straightforwardly held against the object by an operator. Commonly the operator will already have a good idea of where the object might have sub-surface flaws or material defects; for example, a component may have suffered an impact or may comprise one or more drill or rivet holes that could cause stress concentrations. The device suitably processes the reflected pulses in real time so the operator can simply place the device on any area of interest.

The handheld device also comprises a dial 105 or other user input device that the operator can use to change the pulse shape and corresponding filter. The most appropriate pulse shape may depend on the type of structural feature being imaged and where it is located in the object. The operator can view the object at different depths by adjusting the time-gating via the display. Having the apparatus output to a handheld display, such as the tablet 102, or to an integrated display, is advantageous because the operator can readily move the transducer over the object, or change the settings of the apparatus, depending on what is seen on the display and get instantaneous results. In other arrangements, the operator might have to walk between a non-handheld display (such as a PC) and the object to keep rescanning it every time a new setting or location on the object is to be tested.

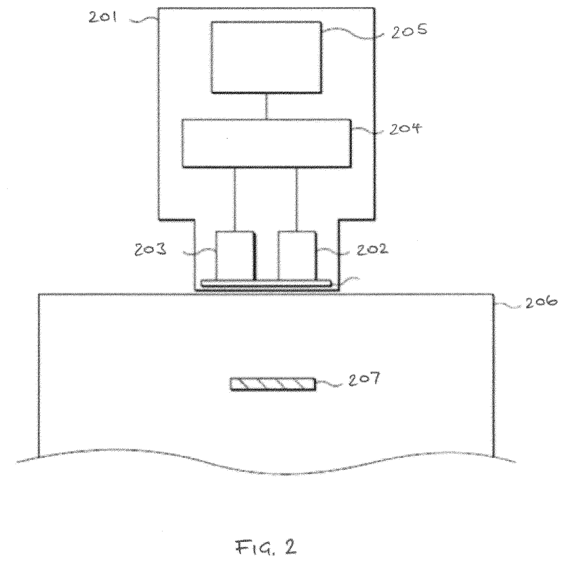

A scanning apparatus for imaging structural features below the surface of an object is shown in FIG. 2. The apparatus, shown generally at 201, comprises a transmitter 202, a receiver 203, a signal processor 204 and an image generator 205. In some examples the transmitter and receiver may be implemented by an ultrasound transducer. The transmitter and receiver are shown next to each other in FIG. 2 for ease of illustration only. The transmitter 202 is suitably configured to transmit a sound pulse having a particular shape at the object to be imaged 206. The receiver 203 is suitably configured to receive reflections of transmitted sound pulses from the object. A sub-surface feature of the object is illustrated at 207.

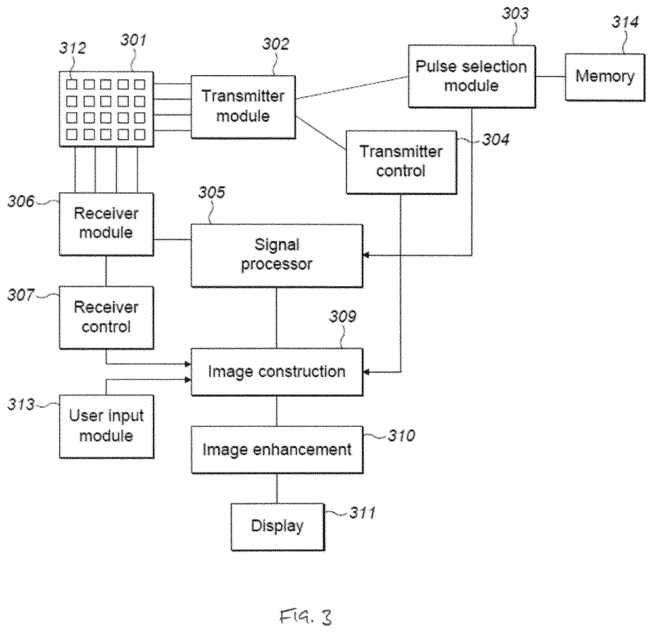

An example of the functional blocks comprised in one embodiment of the apparatus are shown in FIG. 3.

In this example the transmitter and receiver are implemented by an ultrasound transducer 301, which comprises a matrix array of transducer elements 312. The transducer elements transmit and/or receive ultrasound waves. The matrix array may comprise a number of parallel, elongated electrodes arranged in an intersecting pattern; the intersections form the transducer elements. The transmitter electrodes are connected to the transmitter module 302, which supplies a pulse pattern with a particular shape to a particular electrode. The transmitter control 304 selects the transmitter electrodes to be activated. The number of transmitter electrodes that are activated at a given time instant may be varied. The transmitter electrodes may be activated in turn, either individually or in groups. Suitably the transmitter control causes the transmitter electrodes to transmit a series of sound pulses into the object, enabling the generated image to be continuously updated. The transmitter electrodes may also be controlled to transmit the pulses using a particular frequency. The frequency may be between 100 kHz and 30 MHz, preferably it is between 0.5 MHz and 15 MHz and most preferably it is between 0.5 MHz and 10 MHz.

The receiver electrodes sense sound waves that are emitted from the object. These sound waves are reflections of the sound pulses that were transmitted into the object. The receiver module receives and amplifies these signals. The signals are sampled by an analogue-to-digital converter. The receiver control suitably controls the receiver electrodes to receive after the transmitter electrodes have transmitted. The apparatus may alternately transmit and receive. In one embodiment the electrodes may be capable of both transmitting and receiving, in which case the receiver and transmitter controls will switch the electrodes between their transmit and receive states. There is preferably some delay between the sound pulses being transmitted and their reflections being received at the apparatus. The apparatus may include a coupling layer to provide the delay needed for the electrodes to be switched from transmitting to receiving. Any delay may be compensated for when the relative depths are calculated. The coupling layer preferably provides low damping of the transmitted sound waves.

Each transducer element may correspond to a pixel in the image. In other words, each pixel may represent the signal received at one of the transducer elements. This need not be a one-to-one correspondence. A single transducer element may correspond to more than one pixel and vice-versa. Each image may represent the signals received from one pulse. It should be understood that “one” pulse will usually be transmitted by many different transducer elements. These versions of the “one” pulse might also be transmitted at different times, e.g. the matrix array could be configured to activate a “wave” of transducer elements by activating each line of the array in turn. This collection of transmitted pulses can still be considered to represent “one” pulse, however, as it is the reflections of that pulse that are used to generate a single image of the sample. The same is true of every pulse in a series of pulses used to generate a video stream of images of the sample.

The pulse selection module 303 selects the particular pulse shape to be transmitted. It may comprise a pulse generator, which supplies the transmitter module with an electronic pulse pattern that will be converted into ultrasonic pulses by the transducer. The pulse selection module may have access to a plurality of predefined pulse shapes stored in a memory 314. The pulse selection module may select the pulse shape to be transmitted automatically or based on user input. The shape of the pulse may be selected in dependence on the type of structural feature being imaged, its depth, material type etc. In general the pulse shape should be selected to optimise the information that can be gathered by the signal processor 305 and/or improved by the image enhancement module 310 in order to provide the operator with a quality image of the object.

FIG. 4 schematically illustrates a transducer module. The transducer module (TRM) is generally indicated at 400. An electrical connection such as a cable 401 couples the TRM to a remote system. The remote system can provide driving signals and can receive detected signals. The transducer module is shown as being placed against an object under test 402. The TRM comprises a transducer 404. The transducer 404 comprises a transmitter. The transducer comprises a receiver. The transmitter and receiver may be separately provided. Details of the transducer structure and its electrical connections are omitted from this figure for clarity. The transducer is configured to transmit ultrasound signals towards the object to be imaged. The transducer is suitably configured to transmit ultrasound signals in a direction indicated at 406. This can be called the first direction.

A backing block is provided ‘behind’ the transducer. The backing block is the other side of the transducer from the front surface thereof which faces towards an object under test. For example, the backing block can be provided in the TRM along a second direction from the transducer, where the second direction is different from the first direction. Suitably, as illustrated in FIG. 4, the second direction is opposite the first direction. The second direction is illustrated at 410.

The backing block can take any suitable shape. As illustrated, the backing block comprises a tapered section 412 towards the top (in the orientation of FIG. 4) and a flat top 414. The backing block comprises an inner surface 416. At least a portion of the inner surface faces towards the transducer 404. In the illustrated example, the portions of the inner surface at the top and tapered sections face towards the transducer. The inner surface need not face directly towards the transducer, but may face the transducer at an angle.

The inner surface 416 defines a cavity 418 within the backing block. The cavity is suitably bounded by the transducer, as illustrated. The cavity can be filled with a sound-absorbing material. The sound-absorbing material used can be chosen in dependence on the transducer. For example, the sound absorption capabilities of the sound-absorbing material can be selected in dependence on the frequency spectrum of ultrasound transmitted by the transducer. Suitably, the sound-absorbing material absorbs sound in the frequency range transmitted by the transducer. The sound-absorbing material can absorb sound in one or more sub-range of the frequency range transmitted by the transducer. For example, where the transducer is used to scan an object using a particular frequency or range of frequencies, the sound-absorbing material can be configured to preferentially absorb sound in that frequency or in that frequency range. This approach can increase the accuracy of the scan by reducing undesirable reflections at the frequency or in the frequency range of interest.

FIG. 5 shows an illustration of two possible paths of ultrasound signals transmitted by the transducer 502 towards the backing block 504. A first path, shown on the left, is taken by a signal 506 transmitted in the second direction. This signal is reflected at the top inner surface 508 of the backing block. The reflected signal 510 is directed back towards the transducer (in the first direction). A second path, shown on the right, is taken by another signal 512. Signal 512 is not transmitted in the second direction but is transmitted at an angle of less than 90 degrees to the second direction. Signal 512 is reflected at a side inner surface 514. The reflected signal 516 continues at an angle to the second direction to the top inner surface 508. Here, the signal is again reflected and the reflected signal 518 is directed back towards the transducer. Both reflected signals will be detected at the transducer. The first path is shorter than the second path. Thus the signal passing along the first path will undergo less attenuation than a signal passing along the second path.

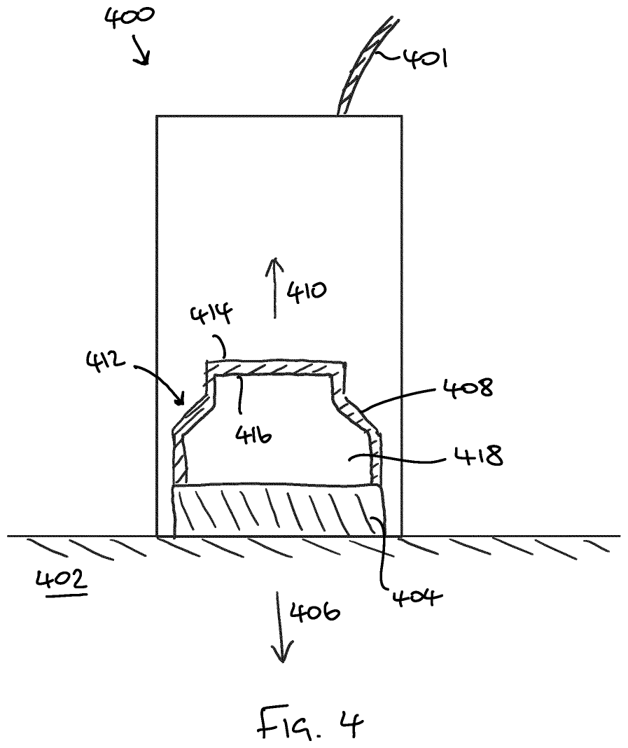

Features that can advantageously further increase the path length, and hence the attenuation, will now be described with reference to the figures. Turning first to FIG. 6, the inner surface 603 of the backing block 604 can be provided with a feature such as a non-planar feature, a surface irregularity and/or a non-uniformity. In general, the feature is configured to reflect or refract a signal transmitted by the transducer 602 such that the path length of the signal before it is detected by the transducer is increased. In FIG. 6 the feature is shown as a pyramidal feature 606 (the figure representing a triangular slice through the pyramid). An ultrasound signal transmitted by the transducer in the second direction towards the pyramidal feature 606 will not be reflected directly back towards the transducer. Instead, the reflected signal will propagate along a path as indicated at 608. The path 608 is longer than the path would have been without the presence of the pyramidal feature. Thus the pyramidal feature results in an increase in the path length.

FIG. 7 illustrates an alternative example. In this example the sides of the pyramidal feature 706 are at a shallower angle to the second direction than the sides of the pyramidal feature 606 illustrated in FIG. 6. Advantageously, the shallower angle of the sides of this feature can result in a further increase in path length by causing a greater number of reflections of the signal before it is detected by the transducer 702. An example of part of the path taken by such a reflected signal is shown at 708.

The features illustrated in FIGS. 6 and 7 are symmetrical, but this need not be the case in all examples.

FIGS. 6 and 7 illustrate a single pyramidal feature provided on the inner surface of the backing block. As illustrated, the feature is provided across a portion of the inner surface less than the whole of the inner surface. The feature may be provided across the whole of the inner surface. Suitably the feature is provided across the portion of the inner surface that faces the transducer. The feature may be provided across the portion of the inner surface that directly faces the transducer.

A plurality of such features is suitably provided. The plurality of features may all be of the same shape and size. At least one of the plurality of features may differ in size from another one of the plurality of features. At least one of the plurality of features may differ in shape from another one of the plurality of features. Different sizes and/or shapes of the features may help cause irregular scattering of signals within the backing block. Irregular scattering of signals within the backing block can lead to at least some of the signals propagating along longer paths.

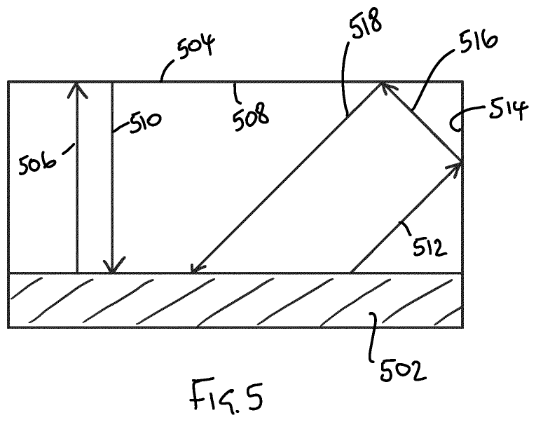

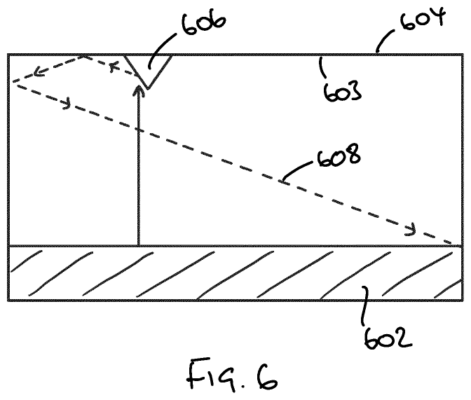

FIGS. 8A and 8B show a sectional side view of another backing block 804. FIG. 8B is an enlargement of the circular section of FIG. 8A. The backing block 804 comprises a non-planar feature provided on the inner surface of the backing block. The feature comprises a plurality of pyramidal features 806. The angle between the flat sides of adjacent pyramidal features is 90 degrees, as indicated at 810. The angle between the flat side of a pyramidal feature and the second direction is 45 degrees. The backing block comprises a tapered section 812. The portion of the inner surface at this tapered section is at an angle of 45 degrees to the second direction. The portion of the inner surface at the tapered section 812 does not comprise any pyramidal features. In an alternative implementation, pyramidal features may additionally or alternatively be provided on the inner surface of the tapered section 812.

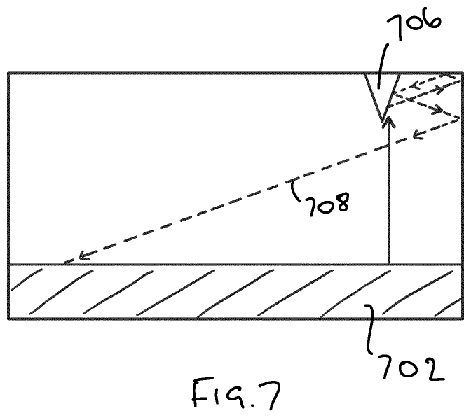

FIGS. 9A and 9B illustrate a plan view and a perspective view, respectively, of the backing block of FIGS. 8A and 8B. The backing block 904 comprises a tapered section 912. The tapered section forms a periphery to a portion of the inner surface comprising a plurality of pyramidal features 906. Four holes 920 are provided for mounting screws. Four such holes need not be provided in all examples. For example there may be more or fewer holes. The backing block need not be provided with any such holes.

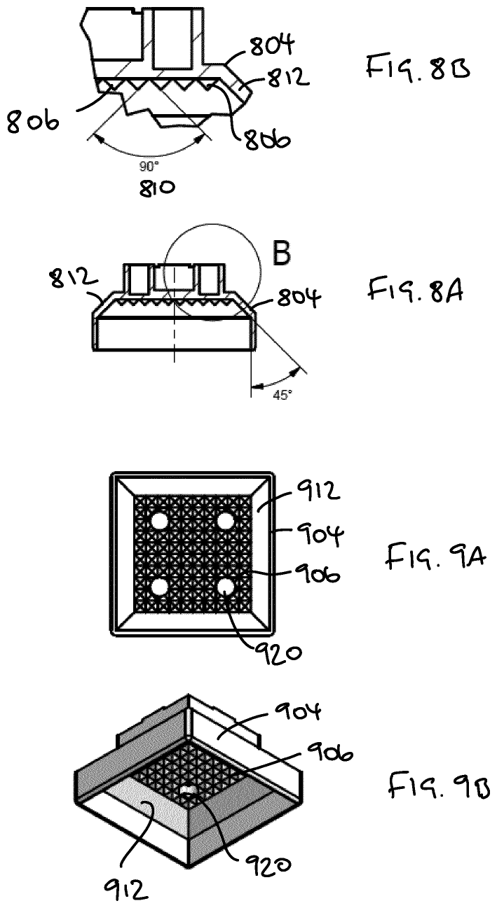

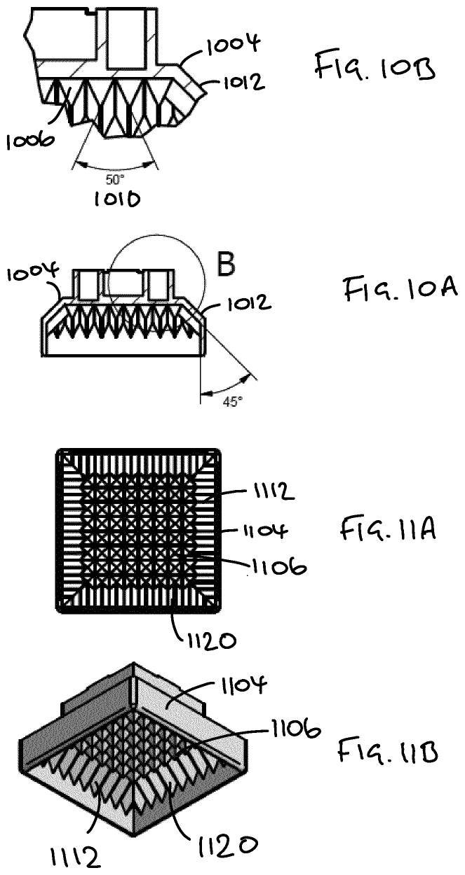

FIGS. 10A and 10B show a sectional side view of another backing block 1004. FIG. 10B is an enlargement of the circular section of FIG. 10A. The backing block 1004 comprises a non-planar feature provided on the inner surface of the backing block. The feature comprises a plurality of pyramidal features 1006. The angle between the flat sides of adjacent pyramidal features is 50 degrees, as indicated at 1010. The angle between the flat side of a pyramidal feature and the second direction is 25 degrees. The backing block comprises a tapered section 1012. The portion of the inner surface at this tapered section is at an angle of 45 degrees to the second direction. The portion of the inner surface at the tapered section 1012 comprises angled features.

FIGS. 11A and 11B illustrate a plan view and a perspective view, respectively, of the backing block of FIGS. 10A and 10B. The backing block 1104 comprises a tapered section 1112. The tapered section forms a periphery to a portion of the inner surface comprising a plurality of pyramidal features 1106. The tapered section comprises a plurality of angular features 1120.

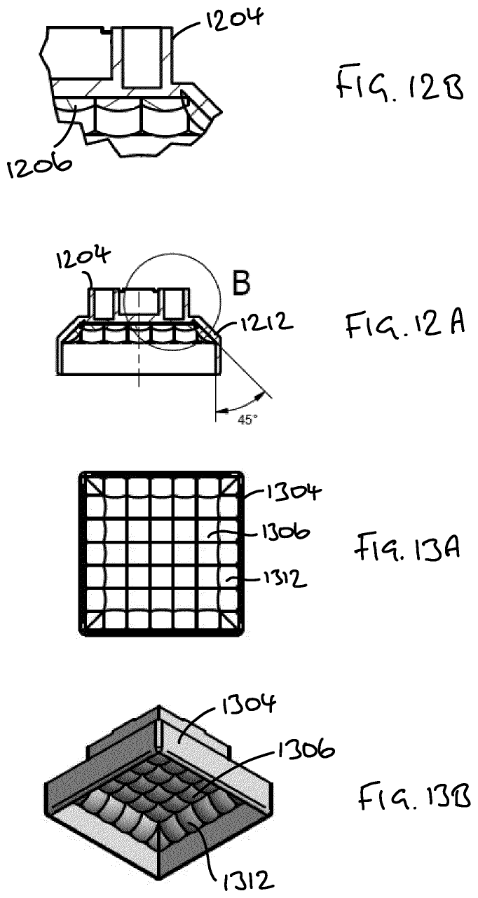

The above description has focused on the non-planar features comprising pyramidal or angled features. In another implementation, the non-planar feature can comprise a curved feature. FIGS. 12A and 12B show a sectional side view of another backing block 1204. FIG. 12B is an enlargement of the circular section of FIG. 12A. The backing block 1204 comprises a non-planar feature provided on the inner surface of the backing block. The feature comprises a plurality of curved features 1206. The backing block 1204 comprises a tapered section 1212. The portion of the inner surface at this tapered section is at an angle of 45 degrees to the second direction. The portion of the inner surface at the tapered section 1012 also comprises curved features.

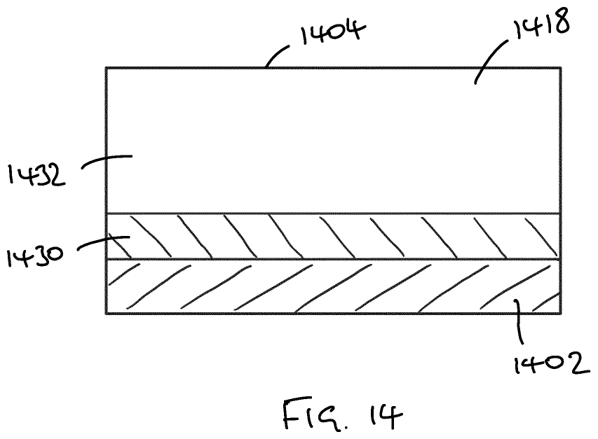

FIGS. 13A and 13B illustrate a plan view and a perspective view, respectively, of the backing block of FIGS. 12A and 12B. The backing block 1304 comprises a tapered section 1312. The inner surface of the backing block 1304 is provided with curved features 1306. The curved features 1306 extend along the inner surface of the tapered section 1312.

In some implementations the non-planar feature may comprise at least one angled feature such as a pyramidal feature and at least one curved feature. Other shapes of features may be provided additionally or alternatively in any combination. The angled and curved features described herein are merely examples of a wide range of feature shapes that can cause the backing block to reflect signals so as to increase the path length of the reflected signals.

In the above examples, the non-planar features are shown as surface protrusions. In other examples the non-planar features may be surface indentations or recesses. In yet other examples the non-planar features may comprise one or more protrusion and one or more recess. Protrusions and recesses may be provided in any desired combination.

The backing block may comprise a sound-absorbing material arranged to increase the absorption of ultrasound signals passing therethrough. The sound-absorbing material may comprise an epoxy or similar material. The epoxy may be formed from an epoxy resin and a hardener such as a polyfunctional hardener (sometimes termed A+B epoxy). For example the sound-absorbing material may comprise NM 625 (obtainable from NILS MALMGREN AB). The sound absorbing material may comprise an encapsulant such as a silicone-based encapsulant. For example, the sound absorbing material may comprise QSi1553, obtainable from the CHT group of companies. The sound absorbing material may comprise a rubber such as polyurethane rubber, for example Aptflex F36, available from Precision Acoustics Ltd. The sound-absorbing material may comprise a plurality of particles. The particles may be dispersed throughout the sound-absorbing material. Suitably the particles have different acoustic impedance to the sound-absorbing material such that the surfaces of the particles provide boundaries which will reflect ultrasound signals passing through the sound-absorbing material. Thus the presence of the particles will increase the number of times that an ultrasound signal is reflected and/or spread out as it passes through the backing block, which will cause the signal to lose more energy due both to reflection losses and increased attenuation due to increased path length.

Suitably the particles can have a range of sizes. Thus the particles may present an irregular series of interfaces to signals propagating through the sound-absorbing material in the backing block. Suitably the particles range in size from particles having a largest dimension of X μm to particles having a largest dimension of Y μm. Preferably, X=0.1 μm. Preferably Y=500 μm. X may be greater than or equal to 0.1 μm, 0.5 μm, 1 μm, 2 μm, 5 μm or 10 μm, and so on. Y may be less than or equal to 500 μm, 450 μm, 400 μm or 300 μm, and so on. Preferably the size of the largest dimension of the particles, and/or the range of sizes of the largest dimension of the particles depends on the frequency or frequency range of ultrasound for absorption and/or scattering by the backing block.

The plurality of particles may comprise spherical particles. The plurality of particles may comprise particles other than spherical particles. The plurality of particles may comprise particles of different shapes. The provision of particles of different shapes can help cause irregular reflections of ultrasound signals within the backing block. The irregular reflections can cause increased numbers of reflections and/or path length.

The plurality of particles can comprise particles of a plurality of materials. Suitably the different materials have different acoustic impedances. Thus the particles of different materials will reflect ultrasound signals differently. This can assist in irregular reflections within the backing block, which can lead to an increased number of reflections and/or an increased path length. At least some of the particles may be in a powdered form.

Suitably the particles comprise a metal. The particles may comprise a plurality of metals. The plurality of particles may comprise particles of one or more of tungsten, nickel, titanium, titanium dioxide, steel and iron oxide. Other materials may be provided as desired. Suitably the material of the particles provided in the backing block is selected in dependence on a desired acoustic impedance of the sound-absorbing material. For example, the inclusion of steel particles into an epoxy can cause the acoustic impedance of the epoxy to become more similar to that of steel. Thus such an epoxy comprising steel particles can be used for impedance-matching to a steel material.

The particles can be provided in any desired concentration in the sound-absorbing material. Suitably, the concentration of particles in the sound-absorbing material is selected in dependence on the frequency or frequencies of ultrasound that the backing block is configured to absorb and/or scatter. The particles may form at least 10% (by weight) of the sound-absorbing material. The particles may form at least 20% (by weight) of the sound-absorbing material. The particles may form at least 30% (by weight) of the sound-absorbing material. The particles may form at least 50% (by weight) of the sound-absorbing material. The particles may form at least 80% (by weight) of the sound-absorbing material.

Preferably the surface of the sound-absorbing material that is provided adjacent the transducer is impedance-matched to the transducer. This can help reduce reflections at the transducer-backing block boundary. Thus a greater proportion of the ultrasound transmitted in the second direction can propagate into the backing block and hence be absorbed therein.

The sound-absorbing material need not be of the same composition throughout the backing block. Suitably, the composition changes along at least the second direction. For example, the sound-absorbing material may be provided in layers in the backing block. An example of this is illustrated in FIG. 14. A backing block 1404 is provided adjacent a transducer 1402. The backing block comprises a cavity 418 within which is provided a sound-absorbing material. The sound-absorbing material comprises a first layer 1430 and a second layer 1432. The first layer is arranged to be adjacent the transducer 1402, and the second layer 1432 is behind the first layer, e.g. along the second direction. The first layer can comprise epoxy with no added particles. Thus the epoxy can easily be impedance-matched to the transducer to enable efficient coupling of ultrasound energy into the backing block. The second layer may comprise an epoxy and particle mix. Thus, after coupling the ultrasound into the backing block, further propagation of the ultrasound signals through the sound-absorbing material will result in an increased number of reflections, leading to increases in energy absorption by the backing block.

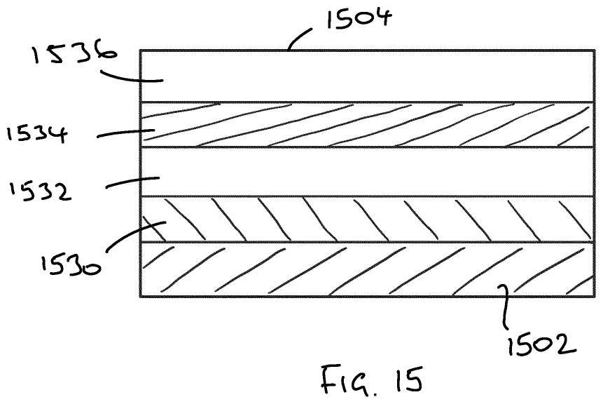

In another example, illustrated in FIG. 15, the sound-absorbing material can comprise additional layers of materials. At least two of these layers can be of different materials. The example in FIG. 15 comprises four layers within the sound-absorbing material, though more or fewer layers may be provided. In general, the first layer 1530 can comprise a sound-absorbing material which contains w % particles (by weight). The second layer 1532 (along the second direction) can comprise a sound-absorbing material which contains x % particles (by weight). The third layer 1534 (further along the second direction) can comprise a sound-absorbing material which contains y % particles (by weight). The fourth layer 1536 (further along the second direction) can comprise a sound-absorbing material which contains z % particles (by weight).

Suitably w is less than or equal to x, less than or equal to y and less than or equal to z. For example, w may be less than x, less than y and less than z. Two or more of x, y and z may be equal to one another. x may be greater or less than y. x may be greater or less than z. y may be greater or less than z.

In some implementations, the impedance of the sound-absorbing material changes progressively in the second direction. In such implementations, w may be less than x; x may be less than y; and y may be less than z.

In some implementations, the impedance of the sound-absorbing material both increases and decreases along the second direction. For example, w may be less than x; x may be greater than y; y may be less than z. Such arrangements may cause additional reflections of signals back away from the transducer. This can lead to further increases in the number of reflections and/or path length before a signal is detected at the transducer.

The backing block may be manufactured in any convenient manner, for example by 3D printing (also known as additive manufacturing), mould injection, machining, and so on. The backing block may be formed from any suitable material. In some examples the backing block is formed from a material with a similar acoustic impedance to the sound-absorbing material contained within the cavity of the backing block. This can help reduce large reflections at the boundary between the sound-absorbing material and the inner surface of the backing block. Suitably the backing block can be formed from or can comprise polyamide.

The sound-absorbing material may be formed by adding particles to a material such as an epoxy and stirring the resulting mix together. The mix can then be poured into the cavity of the backing block and allowed to harden.

A scanning apparatus can comprise a plurality of transducers coupled together. Such an arrangement enables a relatively larger area to be scanned, whilst retaining the scanning resolution offered by a single transducer.

The apparatus and methods described herein are particularly suitable for detecting debonding and delamination in composite materials such as carbon-fibre-reinforced polymer (CFRP). This is important for aircraft maintenance. It can also be used detect flaking around rivet holes, which can act as a stress concentrator. The apparatus is particularly suitable for applications where it is desired to image a small area of a much larger component. The apparatus is lightweight, portable and easy to use. It can readily be carried by hand by an operator to be placed where required on the object.

In one implementation, the transducer could be formed in a pen tip, for example to allow a user to run the pen over a surface for performing a simple thickness test—whether greater than a threshold or not. An LED on the pen can indicate the result.

The structures shown in the figures herein are intended to correspond to a number of functional blocks in an apparatus. This is for illustrative purposes only. The functional blocks illustrated in the figures represent the different functions that the apparatus is configured to perform; they are not intended to define a strict division between physical components in the apparatus. The performance of some functions may be split across a number of different physical components. One particular component may perform a number of different functions. The figures are not intended to define a strict division between different parts of hardware on a chip or between different programs, procedures or functions in software. The functions may be performed in hardware or software or a combination of the two. Any such software is preferably stored on a non-transient computer readable medium, such as a memory (RAM, cache, FLASH, ROM, hard disk etc.) or other storage means (USB stick, FLASH, ROM, CD, disk etc). The apparatus may comprise only one physical device or it may comprise a number of separate devices. For example, some of the signal processing and image generation may be performed in a portable, hand-held device and some may be performed in a separate device such as a PC, PDA or tablet. In some examples, the entirety of the image generation may be performed in a separate device. Any of the functional units described herein might be implemented as part of the cloud.

The applicant hereby discloses in isolation each individual feature described herein and any combination of two or more such features, to the extent that such features so or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A scanning apparatus for imaging an object, comprising:
an ultrasound transducer comprising a transmitter configured to transmit ultrasound signals in a first direction towards an object and a receiver configured to receive reflected ultrasound signals from an object; and
a backing block for absorbing ultrasound signals, located adjacent the transducer along a second direction opposite to the first direction;
the backing block comprising an inner surface facing the transducer, the inner surface at least partially defining a cavity within the backing block bounded by the transducer and being filled with a sound-absorbing material and the inner surface comprising a non-planar feature configured to increase the absorption of ultrasound signals by the backing block.

2. A scanning apparatus according to claim 1, in which the non-planar feature is provided across the whole of the inner surface.

3. A scanning apparatus according to claim 1, in which the non-planar feature comprises one or more surface protrusion and/or surface indentation.

4. A scanning apparatus according to claim 1, in which the non-planar feature comprises one or more of:
a smoothly curving protrusion and/or indentation; and
an angled protrusion and/or indentation.

5. A scanning apparatus according to claim 1, in which the non-planar feature comprises one or more of:
a part-spherical protrusion and/or indentation; and
a pyramidal protrusion and/or indentation.

6. A scanning apparatus according to claim 1, in which the inner surface of the backing block comprises a rear surface parallel to the transducer.

7. A scanning apparatus according to claim 6, in which the inner surface comprises one or more additional surface provided at an angle to the rear surface.

8. A scanning apparatus according to claim 1, in which at least a portion of the non-planar feature is at an angle of greater than 45 degrees to the second direction.

9. A scanning apparatus according to claim 1, in which at least a portion of the non-planar feature is at an angle of less than 45 degrees to the second direction.

10. A scanning apparatus according to claim 1, in which the sound-absorbing material comprises one or more of epoxy, silicone, and rubber.

11. A scanning apparatus according to claim 1, in which the sound-absorbing material comprises a plurality of particles.

12. A scanning apparatus according to claim 11, in which the plurality of particles comprises particles of a range of sizes and/or shapes.

13. A scanning apparatus according to claim 11, in which the plurality of particles have a size in their greatest dimension in the range 0.1 μm to 500 μm.

14. A scanning apparatus according to claim 11, in which the plurality of particles comprises particles of differing materials.

15. A scanning apparatus according to claim 11, in which the plurality of particles comprises one or more metal.

16. A scanning apparatus according to claim 11, in which the plurality of particles comprises one or more of tungsten, nickel, titanium, titanium dioxide, steel and iron oxide.

17. A scanning apparatus according to claim 1, in which the sound-absorbing material is impedance-matched to the transducer.

18. A scanning apparatus according to claim 1, in which the sound-absorbing material comprises layers of differing impedance along the second direction.

19. A backing block for absorbing ultrasound signals in a scanning apparatus, the backing block being configured to be locatable adjacent a transducer along a second direction opposite to a first direction in which the transducer is configured to transmit ultrasound towards an object to be imaged, the backing block comprising an inner surface facing the transducer, the inner surface at least partially defining a cavity within the backing block bounded by the transducer and being filled with a sound-absorbing material and the inner surface comprising a non-planar feature configured to increase the absorption of ultrasound signals by the backing block.

20. (canceled)

21. A scanning apparatus for imaging an object, comprising:
an ultrasound transducer comprising a transmitter configured to transmit ultrasound signals in a first direction towards an object and a receiver configured to receive reflected ultrasound signals from an object; and
a backing block for absorbing ultrasound signals, located adjacent the transducer along a second direction opposite to the first direction;
the backing block comprising an inner surface facing the transducer, the inner surface at least partially defining a cavity within the backing block, the cavity being filled with a sound-absorbing material comprising a plurality of particles of a range of shapes and/or sizes for increasing sound absorption of the sound-absorbing material.
